(19) United States
(12) Patent Application Publication
(10) Pub. No.: US 2025/0020616 A1
(43) Pub. Date: Jan. 16, 2025

(54) METHOD FOR MEASURING SURFACE CARBON LEVEL OF INORGANIC SOLID

(71) Applicant: TOKUYAMA CORPORATION, Yamaguchi (JP)

(72) Inventors: Shunsuke HOSAKA, Yamaguchi (JP); Yasuo NAKAMURA, Yamaguchi (JP); Masaki UEDA, Yamaguchi (JP)

(73) Assignee: TOKUYAMA CORPORATION, Yamaguchi (JP)

(21) Appl. No.: 18/690,523

(22) PCT Filed: Aug. 31, 2022
(86) PCT No.: PCT/JP2022/032695

§ 371 Date: Sep. 12, 2024

(30) Foreign Application Priority Data
Sep. 17, 2021 (JP) 2021-151944

(51) Int. Cl. G01N 30/06; B01D 53/02; G01N 30/02; G01N 30/64; G01N 30/68

(52) U.S. Cl. CPC G01N 30/06; B01D 53/025; G01N 30/68; B01D 2257/504; G01N 2030/025; G01N 2030/642

(57) ABSTRACT

It is a method for measuring surface carbon level of an inorganic solid, comprising heating under oxygen containing atmosphere an inorganic solid stored in an airtight container, suitably an airtight container having a structure wherein a part of a wall surface of the airtight container is extended in the outer direction to form an extended part, and an opening for inorganic solid which is openable and closable by a lid material is provided on an outer end surface of the extended part, and a standard sealing material made of synthetic rubber is intervened on a contact surface with the wall surface of the outer end surface of the extended part of the lid material, to burn the surface, analyzing carbon dioxide level in the container atmosphere after burning by gas chromatography method, and obtaining carbon level of the inorganic solid surface from the obtained result of analysis.

### TECHNICAL FIELD

The present invention relates to a method for measuring surface carbon level of an inorganic solid, specifically to the above-mentioned method comprising oxidizing carbon components adhered to a surface of inorganic solid, to quantify generated carbon dioxide.

### BACKGROUND ART

Polycrystalline silicon is used as a raw material for silicon single crystal growth necessary for the manufacture of semiconductor device, etc., and demand regarding its purity is increasing year by year.

Polycrystalline silicon is most likely manufactured by Siemens process. Siemens process is a method of contacting silane raw material gas such as trichlorosilane with a heated silicon shaft to grow polycrystalline silicon in gas phase on the shaft surface. Polycrystalline silicon manufactured by Siemens process is obtained in a rod state. The polycrystalline silicon in rod state has generally a size having a diameter of 80 to 150 mm, and a length of 1000 mm or more. As such, when using the polycrystalline silicon in rod state in other processes, for example in silicon single crystal growth equipment by CZ method, it is cut into a rod having a prescribed length, or crushed into an appropriate clumped state, or the like. These polycrystalline silicon crushed clumps are classified with sieves, according to need. Then, to remove metal contamination adhered to the surface, after undergoing a cleaning process, for example, generally a method of contacting hydrofluoric acid, or an acidic solution comprising hydrofluoric acid and nitric acid with polycrystalline silicon, etc., it is packed in a packing bag with a high purity in the packing step, and shipped for the above-mentioned use.

Meanwhile, during the manufacturing process of the above-mentioned polycrystalline silicon crushed clump, the surface may be adhered not only with various metal contamination but with organic materials. Such organic materials are incorporated as carbon impurities into the silicon single crystal manufactured using the above-mentioned polycrystalline silicon crushed clump as raw material, and induce decrease in performance of semiconductor device manufactured using the same.

Therefore, it is required to assess the level of carbon contamination with respect to the surface of the polycrystalline silicon crushed clump, and various measuring methods of surface carbon level (surface carbon concentration) with respect to inorganic solid are applied. The most representative method is a method employing combustion-infrared absorptiometric method. Here, measurement of surface carbon concentration of inorganic solid by absorptiometric method is specifically performed as follows. The metal sample is heated under oxygen-containing airflow to burn the surface, the generated combustion gas is introduced into an infrared detecting device, the infrared absorption intensity of carbon monoxide gas (CO gas) and carbon dioxide gas (CO₂ gas) is measured to obtain the above-mentioned surface carbon concentration (for example, patent references 1 and 2).

Further, as a method for analyzing resin adhered to the polycrystalline silicon crushed clump surface, a method that utilizes gas chromatography method is known. This method comprises to increase the temperature of the polycrystalline silicon crushed clump in an inert gas stream, utilizes the gas chromatography method to analyze the decomposition products unique to the resin contained in the decomposed resin, and to specify the type of resin adhered to the polycrystalline silicon crushed clump (Patent Literature 3). However, it is not a method of directly measuring surface carbon concentration which is the subject of the present invention.

### CITATION LIST

### Patent Literature

Patent Literature 1: Japanese Patent Laid-Open Publication No. 2013-040826
Patent Literature 2: Japanese Patent Laid-Open Publication No. 2013-170122
Patent Literature 3: International Publication No. 2018/110653

### SUMMARY OF INVENTION

### Technical Problem

With a method employing the most representative method, the combustion-infrared absorptiometric method, as the method for measuring surface carbon concentration of inorganic solid, the lower quantification limit of carbon is about 0.1 ppmw (with respect to the inorganic solid), and the satisfaction is not enough. This is simply because with the combustion-infrared absorptiometric method, combustion of the metal sample is performed in the oxygen-containing air flow and the combustion gas is continuously discharged out of the heating oven, which is continuously introduced in the infrared detecting device, and that the infrared spectroscopic analysis is performed each time (Patent Literature 1, [0015]; Patent Literature 2 [0113]). Specifically, with this method, the surface carbon concentration is obtained as an integration value of the infrared absorption intensity, in the combustion gas discharged from the initiation to the termination of the combustion of the metal sample surface. Thus, the carbon concentration in the combustion gas each subjected to infrared spectroscopic analysis would be inevitably low, and is sometimes lower than the detection limit. Further, with this method, in case the particle diameter of the metal sample being the subject of measurement is large, or in case it is a crushed clump, etc. and the form of the surface is complex, heating to the combustion temperature of the surface might be non-uniform, and the issue of the low quantification sensitivity is becoming more significant.

Therefore, with such method for measuring surface carbon concentration employing combustion-infrared absorptiometric method, it is necessary to improve its quantification sensitivity, and as in a semiconductor device in which high integration is advanced, the demand of high purity in the raw material is further increasing, and as such improvement of the quantification sensitivity was strongly awaited.

Meanwhile, the above-mentioned method for measuring resin adhered to the polycrystalline silicon crushed clump surface by gas chromatography method is merely a measurement of resin adhered to the surface, and the surface carbon level is not obtained, as in the present invention. Therefore, heating of the polycrystalline silicon crushed clump surface is performed in inactivated gas, and adhered resin is not burned, and is merely decomposed to low molecular organic compound. Therefore, based on this method, even by adding up the carbon level contained in the quantified resin decomposed product, it is limited to those measured in the resin decomposed product, which is only a part of carbon present in the polycrystalline silicon crushed clump surface.

### Solution to Problem

In view of the above problem, the present inventors made a keen study. As a result, they found that by heating under oxygen containing atmosphere an inorganic solid stored in an airtight container to burn its surface, and analyzing an oxygen dioxide level in the container atmosphere after burning by gas chromatography method, the above-mentioned problem can be solved. The present invention has been thus completed.

Specifically, the present invention relates to the following.
[1] A method for measuring surface carbon level of an inorganic solid, comprising heating under oxygen containing atmosphere the inorganic solid stored in an airtight container to burn a surface of the inorganic surface, analyzing an oxygen dioxide level in the container atmosphere after burning by gas chromatography method, and obtaining a carbon level of the inorganic solid surface from the obtained result of analysis.
[2] The method for measuring surface carbon level of an inorganic solid according to [1], wherein the inorganic solid is a polycrystalline silicon crushed clump.
[3] The method for measuring surface carbon level of an inorganic solid according to [2], wherein the polycrystalline silicon crushed clump has a size which at least 90 mass % has a length of longest diameter within a range of 10 to 1000 mm, and a storage level of the polycrystalline silicon crushed clump in the airtight container is 40 g or more.
[4] The method for measuring surface carbon level of an inorganic solid according to any one of [1] to [3], wherein a part of a wall surface of the airtight container is extended in the outer direction to form an extended part, and an opening for inorganic solid which is openable and closable by a lid material is provided on an outer end surface of the extended part.
[5] The method for measuring surface carbon level of an inorganic solid according to [4], wherein a length of the extended part in the airtight container is a length which temperature of an inner space temperature of the outer end surface becomes 200° C. or less when burning the surface of the inorganic solid.
[6] The method for measuring surface carbon level of an inorganic solid according to any one of [1] to [5], wherein the airtight container has a cylindrical structure, and a container heating part which stores and heats the inorganic solid is provided in the inner space of one outer end side, and the opening for inorganic solid is provided on the other outer end surface.
[7] The method for measuring surface carbon level of an inorganic solid according to any one of [1] to [6], wherein the airtight container is made of Hastelloy.
[8] The method for measuring surface carbon level of an inorganic solid according to [6] or [7], wherein one side provided with the container heating part of the airtight container is positioned in an upper part, and the other side provided with the opening for inorganic solid is positioned in a lower part.
[9] The method for measuring surface carbon level of an inorganic solid according to any one of [1] to [8], wherein the analysis of oxygen dioxide level in the gas chromatography method is an analysis using Methanizer (MTN)/Flame Inonization Detector (FID), or a Pulsed Discharge Photo-Ionization Detector (PDD).
[10] An analyzing apparatus for obtaining carbon level of an inorganic solid surface comprising:
   an airtight container that is burnable by heating a surface of inorganic solid which is
   a stored product under oxygen containing atmosphere, and
   a carbon dioxide analyzing part for analyzing carbon dioxide level in an atmosphere of the airtight container by gas chromatography method.
[11] The analyzing apparatus according to [10], wherein a part of a wall surface of the airtight container is extended in the outer direction to form an extended part, and an opening for inorganic solid which is openable and closable by a lid material is provided on an outer end surface of the extended part.,
[12] The analyzing apparatus according to [11], wherein a length of the extended part in the airtight container is a length which a temperature of an inner space temperature of the outer end surface becomes 200° C. or less.
[13] The analyzing apparatus according to any one of to [12], wherein the airtight container has a cylindrical structure, and a container heating part which stores and heats the inorganic solid is provided in the inner space of one outer end side, and the opening for inorganic solid is provided on the other outer end surface.
[14] The analyzing apparatus according to any one of to [13], wherein the airtight container is made of Hastelloy.
[15] The analyzing apparatus according to or [14], wherein one side provided with the container heating part is positioned in an upper part, and the other side provided with the opening for inorganic solid is positioned in a lower part.
[16] The analyzing apparatus according to any one of to [15], wherein the carbon dioxide analyzing part comprises Methanizer (MTN)/Flame Inonization Detector (FID), or a Pulsed Discharge Photo-Ionization Detector (PDD).

### Advantageous Effects of Invention

According to the method of the present invention, it is possible to obtain with high sensitivity and high accuracy the carbon level (carbon concentration) of inorganic solid surface. Therefore, it can be suitably employed in a method of assessing the level of carbon contamination with respect to inorganic solid surface such as polycrystalline silicon crushed clump.

### BRIEF DESCRIPTION OF DRAWING

FIG. 1 is a schematic view showing a representative embodiment of the apparatus for measuring surface carbon concentration of inorganic solid of the present invention.

FIG. 2 is a longitudinal sectional view of the storage heating container constituting the apparatus for measuring surface carbon concentration of inorganic solid of the present invention.

FIG. 3 is a side view from the side of opening for inorganic solid, in the storage heating container of FIG. 2.

FIG. 4 is a front view of a partition wall in a porous embodiment.

### DESCRIPTION OF EMBODIMENTS

It will be explained regarding one embodiment of the present invention in the following. However, the present invention is not limited to this. Further, the “level” in carbon level, carbon dioxide level, etc. of the present invention is a concept including “concentration” such as carbon concentration, carbon dioxide concentration, etc.

### Inorganic Solid

In the present embodiment, inorganic solid being subject of measurement of surface carbon level can be any solid product consisting of any inorganic material. Inorganic materials melt when heating when the melting point is too low, and the measurement level of carbon level might include not only the level present on the surface but also the content of the inside, and the accuracy of the measurement might decrease. Therefore, the melting point of the inorganic material is preferably 800° C. or more, more preferably 1000° C. or more, and most preferably 1200° C. or more.

Specific examples of inorganic material constituting the inorganic solid include non-metal inorganic solid materials such as polycrystalline silicon (polysilicon), monocrystalline silicon, silica, aluminum nitride silicon nitride, alumina, zeolite, and cement; inorganic salts such as potassium chloride sodium chloride; single-component metal such as iron, nickel, chrome, gold, silver, and platinum; alloy such as stainless steel, Hastelloy, and Inconel. Materials for mounting board of electronic components or its raw material, which high level of decrease of carbon contamination is required are preferable, and polycrystalline silicon which such demand is particularly high as stated in the above is most preferred.

Inorganic solid is not particularly limited as long as these inorganic materials are in a state of a solid having a certain size. It can be of any form such as solid substance having square shape, plate form, spherical body, or granulated substance or powder substance, etc. According to the present invention, even a clumped object in which generally, heating might be non-uniform and the above-mentioned quantification sensitivity might be low can be measured with high accuracy, and the effect of the present invention can be significantly exerted, a clumped object is preferable.

As for the size of inorganic solid, it is preferable that at least 90 mass % has a length of longest diameter within the range of 10 to 1000 mm. Since the carbon level on the surface can be measured with high sensitivity, it can be suitably applied to even a clumped object having a large particle diameter which specific surface area becomes smaller, and the effect can be significantly exerted on inorganic solid which at least 90 mass % has a length of longest diameter of 30 mm or more. As for the length of minor diameter, it is preferable that at least 90 mass % is within the range of 5 to 100 mm, and more preferably within the range of 20 to 50 mm.

The most preferable inorganic solid being the subject of measurement in the present embodiment is a polycrystalline silicon crushed clump. As such polycrystalline silicon crushed clump, those obtained by crushing polycrystalline silicon in rod state manufactured by Siemens method are preferable, and those generally having underwent representative treating processes shown in the following, specifically any process among (a) crushing process, (b) cleaning process, (c) packing process, and those having undergone all the processes are particularly preferable. Further, in the (a) crushing process, the produced crushed clump can be subjected to a treatment to make the size even by classification using sieves etc. according to need to adjust the particle diameter. By such classification, the polycrystalline silicon crushed clump is preferred that at least 90 mass % has a length of longest diameter within the range of 20 to 200 mm, particularly preferably within the range of 30 to 100 mm.

In each of these treatment processes, in the (a) crushing process, the surface of the polycrystalline silicon crushed lump might be contaminated with carbon by organic substances, at the time of contact with resin such as resin cover of crushing apparatus, and resin cover of crushing table, or the like. Further, in the (b) cleaning process, the surface of the polycrystalline silicon crushed lump might be contaminated with carbon by organic substances, at the time of contact with resin of cleaning basket, conveyor. Further, in the (c) packing process, the surface of the polycrystalline silicon crushed lump might be contaminated with carbon by organic substances, at the time of contact with resin of packing bags (generally made of polyethylene), gloves used for testing, etc. Further, the (a) crushing process, (b) cleaning process and (c) packing process are generally performed in a clean room, but the surface of the polycrystalline silicon crushed clump is contaminated with carbon by organic substances with volatile organic substances being present in the clean room in minute amounts, for example additives discharged from curtain or floor material in the clean room, made of polyvinyl chloride. It is known that organic particles are present in the clean room, and these also might be adhered to polycrystalline silicon.

In the measurement method of the present embodiment, the inorganic solid is stored in a storage heating container (airtight container) having an airtight structure, heated in the container under oxygen containing atmosphere, to burn organic substances present on the surface of the inorganic solid. As such, carbon contained in the organic substances is released in the airtight atmosphere as carbon dioxide. Then, after burning, in the atmosphere in the container, carbon dioxide of all carbons contained in the organic substances is accumulated. In the present invention, such accumulated carbon dioxide is analyzed by gas chromatography method which is a means for measuring such substance with high sensitivity, to enable to obtain in a precise manner the surface carbon level of the inorganic solid with the lower quantification limit than the conventional method employing combustion-infrared absorptiometric method, or the like.

### Storage Heating Container of Inorganic Solid (Airtight Container)

In the present invention, if the airtight container to be the storage heating container of inorganic solid has a heat resistance at a heating temperature of the inorganic solid stated in the following, and is consisted of materials that do not generate carbon dioxide in an oxygen containing atmosphere at the time of heating, it can be used without limitation. The size of the container is preferably 50 ml or more, more preferably 500 ml or more, and most preferably 1000 ml or more. By considering the cost, time for heating, or the production cost of the apparatus, it is preferably 100,000 ml or less, and more preferably 10,000 ml or less.

The inside of these airtight containers would have a high pressure depending on conditions, and those having pressure resistance are preferable. The suitable pressure resistance is 0.2 to 5 MPaG, more preferably 0.5 to 4 MPaG, and particularly preferably 1.0 to 3.0 MPaG.

Specific examples of material of airtight container include metal such as iron and nickel; alloys such as stainless steel, Ni based alloy (Hastelloy, Inconel, etc.); glass; ceramics, etc. Particularly, Ni based alloy (Hastelloy, Inconel, etc.) which has heat resistance, and elution of carbon from container materials is suppressed, is thus particularly preferable, and Hastelloy is the most suitable. Further, in case of material not having pressure resistance such as glass, it can be used by lining inside the metal container.

The form of the airtight container can be suitably selected from square, cylindrical form, etc. From the point of inserting and removing inorganic solid being the sample, manufacture and easiness to handle of the container, cylindrical form is preferred. To the wall surface of these containers, a gas supply pipe to make inside of the airtight container an oxygen containing atmosphere, etc. and an inner gas-discharging pipe for supplying air to the analyzing apparatus for analyzing the container atmosphere by gas chromatography method after burning the inorganic solid surface are each connected. Naturally, for these gas supply pipe and inner gas-discharging pipe, it is necessary to provide an on-off valve at the end of connection or in the middle of the pipe so that the inside of the container is in an airtight state when burning the inorganic solid surface. Further, these gas supply pipe and inner gas-discharging pipe can be connected to the container with a common pipe, and to branch to each pipe in the middle, and to use each pipe by operating the on-off valve provided to each pipe.

Further, generally on a part of the wall surface of the container, an opening for inorganic solid, having an openable and closable structure by a lid material is provided. Such lid material can have a structure that shields the opening for inorganic solid by providing a circumferential lib at the periphery of the opening for inorganic solid, on which the cap-state lid material is covered, and securing with bolts at plural locations, or a structure that shields the opening for inorganic solid by abutting the plate-form lid material at the periphery of the opening for inorganic solid, and securing with bolts at plural locations, etc.

Further, it is preferable to maintain sealability by intervening a sealing material on the contact surface with the lid material, at the periphery of the opening for inorganic solid. As for such sealing material, any of a standard sealing material (gasket, packing, etc.) made of synthetic rubber (vinylidene fluoride (FKM), ethylene-propylene rubber (EPT), perfluoroelastomer (FFKM), ethylene-propylene rubber (EPM), ethylene-propylene-diene rubber (EPDM), etc.; and irregular sealing material consisting of inorganic filler (silicon, alumina fiber, aramid fiber, etc.) paste can be used, while generally standard sealing material is used from the point of having good sealability. Particularly, those consisting of perfluoroelastomer such as tetrafluoroethylene-perfluorovinyl ether etc. are preferable, and as marketed products, “Kalrez” (product name; manufactured by DuPont), “DUPRA” (product name; manufactured by TOHO KASEI) etc. are most suitable.

As such when using standard sealing material made of synthetic rubber, since the heat resistance temperature of the synthetic rubber is lower than the heating temperature of the inorganic solid as mentioned in the following, there is a concern that during this process, the shape changes and the airtightness of the container is decreased, or when it is burned and carbon dioxide is released, the accuracy of the carbon level of the inorganic solid surface is decreased. From the viewpoint of preventing such issue, it is preferable that the airtight container has a structure wherein a part of the wall surface is extended in the outer direction to form an extended part, and an opening for the inorganic solid is provided on an outer end surface of the extended part. Particularly, as shown in the longitudinal sectional view of the storage heating container 1 shown in FIG. 2, it is preferred to be an embodiment having a cylindrical structure, and a storage heating part 3 which is the part that stores and heat the inorganic solid 2 is provided in the inner space of one outer end side, and the opening for inorganic solid 4 is provided on the other outer end surface. With this structure, the region of the other end side would be the extended part (structure in which a part of the wall surface is extended in the outer direction) 5, rather than the storage heating part 3 of the inorganic solid 2 on the one end side. Further, on the outer end surface of the extended part 5, the opening for inorganic solid 4 is provided, and the opening is shielded with an openable and closable structure by covering the plate-form lid material 7 on the circumferential lib 6 provided on the peripheral wall of the outer end surface of the extended part, and to fix with bolt 8 at plural sites. Further, a gas supply pipe 9 and an inner gas-discharging pipe 10 are inserted in the plate-form lid material 7, to enable gas supply inside the storage heating container 1 and discharge of inner gas.

With the above structure, the opening for inorganic solid 4 can be sufficiently arranged apart from the storage heating part 3 of inorganic solid 2, in the inner space of the storage heating container 1 by the presence of the extended part 5. Therefore, at the time of heating the inorganic solid 2 that has been stored, the inner gas temperature in the vicinity of the opening for inorganic solid 4 can be maintained below the heat resistance temperature of the standard sealing material made of synthetic rubber (not shown) provided at the opening for inorganic solid 4, and the problems of decrease in sealability or discharge of carbon dioxide can be resolved. Here, the length of the extended part 5 is a length so that the inner space temperature becomes 200° C. or less, more preferably 150° C. or less, particularly preferably 80° C. or less. Generally, it is preferable that the length is 20 cm or more, more preferably 30 cm or more. On the other hand, since when the extended part 5 is too long, the container would be excessively large, and generally it is preferable that the length is 100 cm or less, more preferably 50 cm or less.

Further, in order to set the temperature at the periphery of the opening for inorganic solid 4 to be below the heat resistance temperature of the standard sealing material made of synthetic rubber, a cooling pipe can be arranged on the container wall surface at the periphery of the opening for inorganic solid 4, and further the gas can be cooled by applying cold air by arranging a cooling fan in the vicinity.

In the storage heating container 1, it is preferable to provide a partition wall 11 having communication between each other in the boundary part of the extended part 5 and the storage heating part 3 of the inorganic solid 2, to prevent the movement of inorganic solid to the extended part. To have communication between each other, it is preferable that the partition wall 11 is porous or reticular. For example, FIG. 4 is a front view of the partition wall 11 in a porous embodiment, and plural communication holes 13 are uniformly formed in the entire wall surface. The pore diameter of the communication hole is preferably 1 to 20 mm, more preferably 2 to 10 mm, by considering the prevention of movement of the inorganic solid 2 and convection of inner air. The void space rate with respect to the wall surface is preferably 10 to 50%, more preferably 20 to 40%. Here, the partition wall 11 is connected with the supporting rod 12 having a length of reaching the opening for inorganic solid, on the side surface of the opening for inorganic solid 4, and it is preferable that the partition wall 11 has a structure that can be arranged at the prescribed position in the container by pushing/pulling the supporting rod 12.

In case the storage heating container 1 has a cylindrical structure, generally, the arrangement is horizontal in the cylindrical shaft direction. As other embodiment, an embodiment of arranging the end part side provided with the storage heating part 2 of the inorganic solid on the upper side, and the other end part side provided with the extended part 5 (opening for inorganic solid 4) on the lower side is preferable since the high temperature atmosphere can be easily gathered at the storage heating part at the time of heating the inorganic solid, thus increasing the heating effectivity, and that further the lowering effect of the inner space temperature on the extended part 5 side can be enhanced. The inclination angle is preferably 10° C. or more from the viewpoint of increasing the heating effectivity, and more preferably 20° C. or more. There is no upper limit for the inclination angle, and even if the storage heating container 1 is vertically positioned, if the partition wall 11 is provided in the inner space, most of the movement of the inorganic solid 2 to the extended part side can be prevented, and thus is allowable. However, since fine particles of the inorganic solid being smaller than the hole diameter of the communication holes formed on the partition wall 11 might fall on the extended part 5 side, and further the inorganic solid 2 might accumulate on the partition wall 11, and the convection of the inner air after the heating process might be impaired, the inclination angle is preferably 45° C. or less, and more preferably 30° C. or less.

In the present embodiment, the volume of the storage heating container 1 (including the volume of the extended part) is not particularly limited as long as it can store the inorganic solid to be stored at an amount necessary for measurement, and that has an inner space possible to fill the oxygen containing atmosphere at an amount burnable for the entire surface of the inorganic solid that has been stored. Generally, it is 50 ml or more, and in case of using inorganic solid of the lower limit of the aforementioned suitable range (at least 90 mass % has a length of longer diameter of within the range of 10 to 1000 mm), it is preferably 100 ml or more, and in case of using one of the upper limit, it is preferably 1000 ml or more.

In case the storage heating container 1 has a cylindrical shape as shown in FIG. 2, to achieve the above-mentioned suitable container volume, the diameter of the inner space would be 10 mm or more, and when the inorganic solid to be stored is within the aforementioned suitable range, in case of using one of a lower limit, the diameter of the inner space is preferably 25 mm or more, and in case of using one of an upper limit, it is preferably 100 mm or more.

### Heating Method of Inorganic Solid

Heating the inorganic solid stored in the storage heating part of the storage heating container is not limited as long as it is a method that can burn the surface under oxygen containing atmosphere. For burning, it is necessary to completely burn the carbon to carbon dioxide, and preferably, it is desired to heat the surface of the inorganic solid sample to 600° C. or more. The ignition point of most carbon compounds is less than 650° C. under air atmosphere, and for example it is known that the ignition point of carbon monoxide is 610° C., and the ignition point of coke is 600° C. or less. From these, it is preferable to heat so that in the storage heating part of the storage heating container, the inner space temperature in the vicinity of the inorganic solid becomes 650 to 1200° C.

The heating can be either an internal heating method in which the heating element is arranged in the inner space of the storage heating container, or an external heating method in which the heating element is arranged on the outside of the storage heating container. The external heating method is preferable, and examples include a method of providing in addition the heating element on the container wall surface, such as winding ribbon heater etc. on the wall surface, and a method of setting the storage heating container in the heating oven, such as resistance heating oven or induction heating oven, etc.

### Oxygen Containing Atmosphere

To burn the surface of inorganic solid, it is necessary that the oxygen containing atmosphere formed in the storage heating container contains oxygen in an amount enabling the burning, and the oxygen concentration is preferably 10 mass % or more, more preferably 20 to 100 mass %. In case carbon dioxide, or gas that becomes carbon dioxide upon oxidation (carbon monoxide, hydrocarbon such as methane) is contained in the oxygen containing atmosphere, when analyzing the carbon dioxide concentration in the container atmosphere after burning, and aiming to obtain the surface carbon level of the inorganic solid from this level according to the method of the present embodiment, it is necessary to decrease the carbon dioxide level derived from carbon that was contained in advance. Further, in case the carbon dioxide level in the container atmosphere after burning is too high due to the carbon in advance, it might also affect the quantification level. Therefore, in the oxygen containing atmosphere, the concentration of impurities including carbon is preferably less than 100 ppbv in total level, more preferably less than 10 ppbv, and particularly preferably less than 1 ppbv.

From the above, for the oxygen containing atmosphere, an embodiment substantially not containing carbon, and containing the above-mentioned oxygen in inactive gas is preferable. Here, as inactivate gas, nitrogen, helium, and argon are preferable. Further, in the oxygen containing atmosphere, for gas other than oxygen, in case of using hydrogen, when performing detection of gas chromatography method as mentioned in the following, by using Methanizer (MTN)/Hydrogen Flame Ionization Detector (FID), and when reducing carbon dioxide with MTN, it is not necessary to add hydrogen in addition, and thus is favorable. For these inactivate gas, it is preferable to use those having high purity, such as G1 grade, etc., respectively.

Further, for gas other than oxygen, it is preferable to be the same species as the carrier gas in the analysis of carbon dioxide level by gas chromatography method, from the viewpoint of stability of the base line in the detection. As carrier gas, nitrogen and helium, being gas widely used, are particularly preferable.

### Analysis of Carbon Dioxide Level in the Container Atmosphere

In the embodiment of the present invention, after burning the inorganic solid surface in the storage heating container, analysis of carbon dioxide level in the container atmosphere is performed by gas chromatography method (GC method). As for the method of analyzing carbon dioxide level in the gas, Infrared detection device (IR) and Cavity Ring Down Spectroscopy (CRDS) etc. are well known other than the above-mentioned GC method. However, since GC method can measure the carbon dioxide level in the gas with high sensitivity and high accuracy, and the use of adsorbent for condensing gas is easy, it is employed in the present invention. Meanwhile, analysis of carbon dioxide level by GC method in the present invention includes not only directly analyzing the separated carbon dioxide, but also to convert the separated carbon dioxide to other substances and analyze the level of the converted substance.

For the detection of GC method, Methanizer (MTN)/Hydrogen Flame Ionization Detector (FID), Pulsed Discharge Photo-Ionization Detector (PDD), Mass Spectrometry (MS), TCD, Barrier Discharge Ionization Detector (BID), etc. can be used. The lower limit of detection of carbon dioxide in gas is generally for PDD method 10 ppbv, MTN/FID method 100 ppbv, MS method 100 ppbv with the measurement by Selected Ion Monitoring (SIM) mode. This is significantly superior as compared with the quantification lower limit of carbon dioxide being at most 20 ppmv (optical path length 10 cm) in Infrared absorption method being a detection method of combustion-infrared absorptiometric method, which was commonly used for the conventional measurement of surface carbon concentration of inorganic solid.

Among the above-mentioned detection methods, MTN/FID method, PDD method are preferable from the point of sensitivity, easiness to handle and being relatively of low cost. MTN/FID method is particularly favorable. By explaining this in detail, it is a method of mixing the carbon dioxide separated by subjecting the sample gas to gas chromatography method with hydrogen by MTN, contacting with reducing catalyst to generate methane, and to detect the methane by FID. As for the reducing catalyst of the Methanizer, those known to be able to be reduced to methane by mixing hydrogen with carbon monoxide or carbon dioxide can be used without limitation, and generally nickel catalyst is used. In case it is a concern that when introducing oxygen to reducing catalyst or detector, the reducing catalyst or detector might be deteriorated, it is possible to separate oxygen in the column, and then to discharge out of the system, and to introduce the obtained carbon dioxide to reducing catalyst or detector. Further, it is possible to separate accurately carbon dioxide in the column of the second stage after separating oxygen. Further, depending on the column to be used, it is also possible to use Back Flash method.

As for column of GC method, it is sufficient to select and use those can separate other gas components such as nitrogen-oxygen-inactivate gas, etc. (each of those do not have be separated) and carbon components being the subject necessary to measure carbon level in the combustion gas. Specifically, if the detection method is MTN/FID method, the separation ability with the above-mentioned other gas components, particularly carbon monoxide, methane is required, and if it is PDD method or MS method, the separation ability of the above-mentioned gas components with carbon dioxide is required.

As for column, packed column or capillary column can be either used. As for filler of packed column, those having the above-mentioned separation ability are selected from among the adsorption type filler, etc. In a packed column, as for marketed products suitable for MTN/FID method, PDD method, examples include Shincarbon-ST (manufactured by Shinwa Chemical Industries Ltd.), Porapak Q (manufactured by GL Sciences), Porapak N (manufactured by GL Sciences), Unibeads 1S (manufactured by GL Sciences), etc. On the other hand, as for liquid phase or adsorbents to be fixed to the column inner wall of the capillary column, those having the separation ability are selected from among divinylbenzene polymer, activated carbon, silica, etc. In a capillary column, as for marketed products suitable for MTN/FID method, PDD method, examples include MICROPAKED-ST (manufactured by Shinwa Chemical Industries Ltd.), TC-BOND U (manufactured by GL Sciences), etc. and for marketed products suitable for MS method, examples include Gas Pro (manufactured by J & W).

It is preferable for the combustion gas, before subjecting to the GC method column, to adsorb carbon dioxide being subject of measurement by using adsorbent, and to desorb and concentrate the same for use in analysis, from the viewpoint of increasing sensitivity. Thereby, it is also possible that the lower limit of detection of carbon dioxide level be 1/100 to 1/10000. As for the adsorbent, those known for this use can be used without limitation, and specifically Shincarbon-ST (manufactured by Shinwa Chemical Industries Ltd.) etc. can be used, and the adsorbing method can be performed by cooling, and the desorption of the adsorbed carbon dioxide can be performed by heating.

The inlet pressure to the column of the sample gas is preferably a pressurized condition to prevent mixing of carbon dioxide in the atmosphere. Generally, it is 0.10 to 0.50 MPaG, and more preferably 0.15 to 0.30 MPaG. Further, the oven temperature until the carbon dioxide is eluted is generally 40 to 150° C., and more preferably 60 to 100° C. After carbon dioxide is eluted, the impurities can be removed by heating to the upper limit temperature of the column.

Further, when detecting by the MTN/FID method, since measurement of carbon dioxide is affected by oxygen, it is preferable to set to a condition (oven temperature, flow rate, column, etc.) in which the retention time of oxygen and carbon dioxide is separated by one minute or more.

In the present embodiment, the injection volume of the sample gas to the column is generally 0.1 to 5 ml, and more preferably 0.5 to 2 ml. In order to introduce sample gas in such amount with high accuracy in the column, it is preferable to provide a sample loop having a loop volume of the sample gas level or more in the upstream, rather than introduce directly the combustion gas flowing in the inner air-discharging pipe from the storage heating container. Specifically, it is effective that the combustion gas flowing in the inner air-discharging pipe is once sent into the sample loop, and that the combustion gas at a loop volume is introduced in the column as sample gas.

### Measurement Operation of Surface Carbon Level of Inorganic Solid

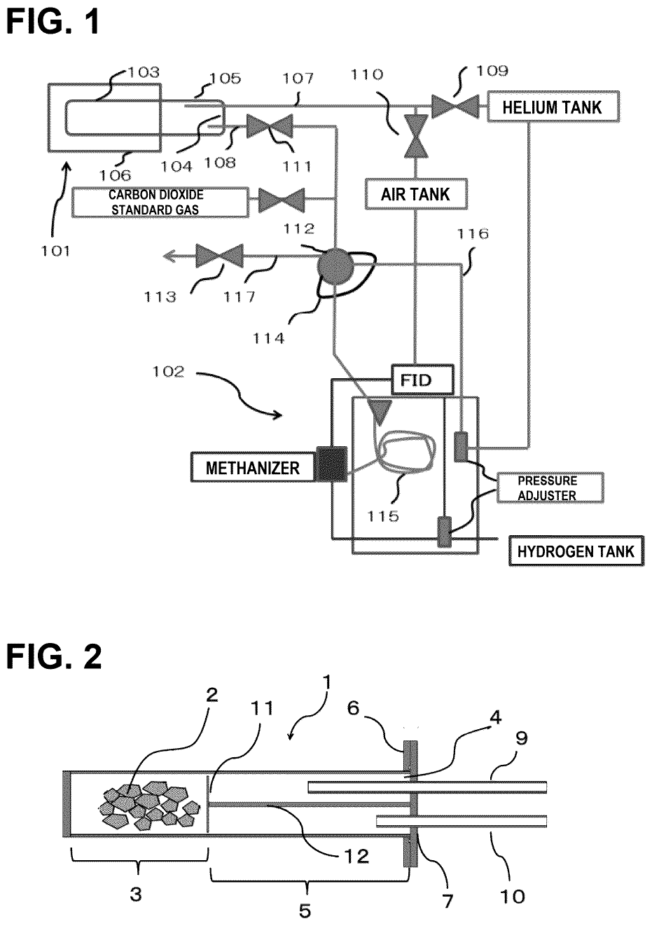

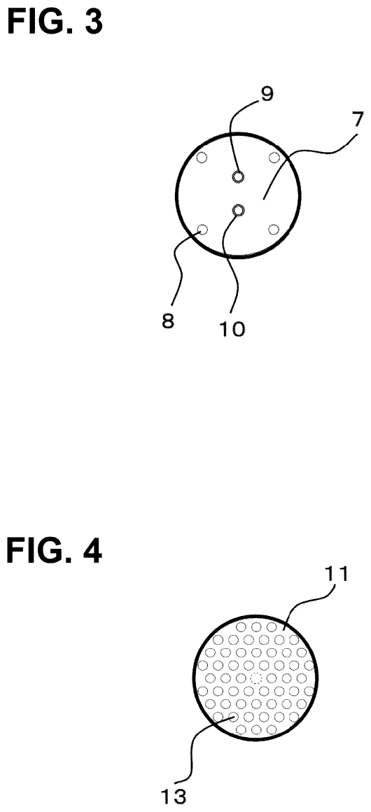

The specific operation of the method for measuring surface carbon level of an inorganic solid of the present embodiment is explained by using FIG. 1 showing a representative embodiment of the measurement apparatus. Specifically, FIG. 1 shows, as a schematic view of an analyzing apparatus of the present embodiment, an analyzing apparatus for obtaining carbon level of an inorganic solid surface, consisting of an airtight container, comprising a storage heating container 101 for inorganic solid, which in the inner space, an oxygen containing atmosphere can be filled, and that is burnable by heating the surface of the stored product, and a carbon dioxide analyzing part 102 for analyzing the carbon dioxide level in the atmosphere of the storage heating container by gas chromatography method. Further, by providing a converting part that converts the carbon dioxide level to the surface carbon level of an inorganic solid to the analyzing apparatus of the present invention, it becomes an apparatus for measuring surface carbon level of an inorganic solid.

In the analyzing apparatus, the storage heating container 101 which is an airtight container, has a cylindrical structure as shown in FIG. 2, and one end side of the side on which the storage heating part 103 of inorganic solid is formed in the inner space is fitted in the resistance heating oven 106. The storage heating container 101 might be adhered with carbon on the wall surface, and since impurity carbon might be released from the wall surface at the beginning of heating, it is required that void heating is performed until there is no such release of carbon under oxygen containing atmosphere before use. Suitable temperature of void heating is 750 to 1200° C., more suitably 800 to 1000° C. The heating time is generally adopted from 1 to 20 hours.

In the storage heating part 103 of inorganic solid, the storage level of inorganic solid (not shown) is not particularly limited, since in case it is too small the generation level of carbon dioxide would be small, it is preferably 40 g or more, more preferably 100 g or more, and particularly preferably 500 g or more. The upper limit of the storage level is not particularly limited, while from the viewpoint that the apparatus would not be excessively large, it is preferably 10000 g or less, and more preferably 1000 g or less.

When storing inorganic solid in the storage heating part 103, external air can be easily flow in the container from the opening for inorganic solid 104 which is opened. Generally, since carbon dioxide is said to be contained in an amount of about 420 ppmv in the atmosphere, when external air flow in the container as such, the accuracy of the measurement of carbon level of inorganic solid surface might be decreased. Therefore, before heating the inorganic solid, it is preferable to replace the container atmosphere with inactive gas. As inactive gas, the same as explained in the above-mentioned oxygen containing atmosphere can be suitably used. Introduction of inactive gas (helium in FIG. 1) in the container is performed from the gas supply pipe 107. According to this, the previous inner gas of the storage heating container 101 is discharged from the inner air-discharging pipe 108, and by operating the six-valve 112 and the on-off valve 113, it passes through the out of system-discharging pipe 117 to be discharged out of the system. When replacement to inactive gas (helium in FIG. 1) is terminated, by closing the on-off valves 109, 110, 111 provided on each pipe, the container is in an airtight state. Further, it is preferable to analyze the carbon dioxide level in the atmosphere by GC method after replacing with the inactive gas to confirm that the replacement is sufficient.

When the container atmosphere is replaced with inactive gas, then by similarly utilizing the gas supply pipe 107 and inner air-discharging pipe 108, the container atmosphere is replaced with oxygen containing atmosphere. At that time, to prevent mixing of external air (including carbon dioxide, methane, carbon monoxide, etc.) in the container, and further after heating so that the container atmosphere is easily insufflated to the inner air-discharging pipe 108, it is preferable to adjust the pressure in the container to be a little higher than the atmospheric air pressure. When the pressure is excessively high, since the carbon dioxide concentration in the combustion gas becomes thin, the container pressure is preferably 0.01 to 2.0 MPaG at 25° C., more preferably 0.1 to 1.0 MPaG, and particularly preferably 0.2 to 0.5 MPaG.

Heating of inorganic solid is performed by heating the storage heating part 103 by the resistance heating oven 106. As such, the surface of inorganic solid is heated at high temperature (as stated above, suitably 600° C. or more), while at that time, the opening for inorganic solid 104 provided on the other end side (opposite side of the side provided with the storage heating part) of the storage heating container is sufficiently arranged apart from the storage heating part 103 having high temperature, by the intervention of extended part 105. Therefore, in the outer end surface provided with the opening for inorganic solid 104, the inner space temperature can be as low as 200° C. or less, and even when the sealing of the opening for inorganic solid 104 is performed by a standard sealing material made of synthetic rubber, it is possible to prevent heat deterioration thereof. Therefore, by the heating, the standard sealing material made of synthetic rubber would not change the form and decrease the airtightness of the container, or release carbon dioxide by burning, and decrease the measurement accuracy of the carbon level of inorganic solid surface.

By the heating under oxygen containing atmosphere, carbon that was present on the surface of inorganic solid is burned, and released as carbon dioxide. To complete this burning, it is preferable to perform the heating for 20 min. or more, and more preferably for 30 to 120 min.

After the completion of the heating, the on-off valve 111 of the inner air-discharging pipe 108 is opened, the atmosphere of the container (combustion gas) is flew into the inner air-discharging pipe, to pass through the six-valve 112 to impregnate combustion gas in the sample loop 114. When reaching the default pressure (in Example 1, 0.15 MPaG), the on-off valve 113 is closed. Then, by operating the six-valve 112, carrier gas of GC (helium) 116 is circulated in the sample loop 114, the burning gas in the sample loop 114 is injected in the column 115 together with the carrier gas of GC, to analyze the carbon dioxide level by GC method.

In the obtained results of analysis of carbon dioxide level, in case the inclusion of carbon dioxide that is not caused by the release from the inorganic solid surface being the subject of measurement, caused by the heat deterioration of the container material or the standard sealing material made of synthetic rubber used for sealing the opening for inorganic solid is observed, in void heating of the storage heating container 101, it is preferable to previously obtain the inclusion level by void heating, substrate it from the analytical level of carbon dioxide level, and subject to reduction of carbon level of inorganic solid surface.

### Reduction for Obtaining Carbon Level of Inorganic Solid Surface From the Results of Analysis of Carbon Dioxide Level of Combustion Gas

Here, reduction for obtaining carbon concentration of inorganic solid surface from carbon dioxide concentration of combustion gas, that is commonly used is explained.

Carbon concentration of inorganic solid surface is calculated by the following formula using the carbon dioxide concentration obtained by GC method.

(carbon concentration of inorganic solid surface)=(carbon dioxide level generated from inorganic solid surface)×12 (atomic weight of carbon)/44 (molar weight of carbon dioxide)/(inorganic solid weight)

(carbon dioxide level generated from inorganic solid surface)=(carbon dioxide level in the storage heating container after heating)—(carbon dioxide level in the storage heating container generated at the time of void heating, previously measured)

(carbon dioxide level in the storage heating container after heating)=(carbon dioxide concentration analyzed by GC method)×(volume of gas in the storage heating container in a standard state)×44 (molar weight of carbon dioxide)/22.4 L (volume of 1 mol of gas in a standard state)

(volume of gas in the storage heating container in a standard state)=273.15/(Kelvin temperature before heating)×(pressure before heating) (atm)×(volume of storage heating container)−(weight of stored inorganic solid)/(specific gravity of stored inorganic solid)

### EXAMPLES

In the following the present invention is further explained in detail by showing Examples, while the present invention is not limited to these Examples.

For the measurement of carbon dioxide level (carbon dioxide concentration) of the sample gas, GC method analyzing apparatus, GC-2014 of SHIMADZU CORPORATION was used, and the measurement was performed with the following conditions. Pressure control of hydrogen and air was performed with GC-2014.

### Column Conditions

Capillary column: MICROPACKED ST (Product name: Shinwa Chemical Industries Ltd.), column diameter 1.0 mm, column length 200 m
Column entrance pressure: 233 kPaG
Column flow volume: 6 ml/min
Injection volume: 1 ml
Inlet temperature: 100° C.
Oven temperature: 80° C. (raise to 250° C. after elution of carbon dioxide, and maintain for 5 min.)
Air pressure for FID: 50 kPaG
Hydrogen for FID: Utilize hydrogen after passing through Methanizer

### Detection Method

MTN/FID method
   Methanizer apparatus: MT221 (GL Sciences)
   Catalyst: nickel catalyst
   Methanizer temperature: 380° C.
   Hydrogen pressure: 60 kPaG
PDD method
   Apparatus: GC-4000 (GL Sciences)
   Detector temperature: 120° C.
MS method
   Apparatus: 5977B GC/MSD (Manufactured by Agilent)
   Ion source, quadrupole temperature: 230° C., 150° C.
   SIM monitor ion: 44

### Lower Detection Limit of Carbon Dioxide

For the GC method analyzing apparatus of carbon dioxide (MTN/FID method), the lower detection limit of carbon dioxide was calculated by the following method. First, it was analyzed by using standard gas of helium base carbon dioxide concentration 10 ppm, to confirm the retention time of carbon dioxide. After filling G1 grade helium at 0.15 MPaG in a sample loop 114 (volume 1 ml), it was analyzed to confirm the noise width around where carbon dioxide is detected. In the Examples of the present specification, it was analyzed with a pressure in the sample loop of 0.15 MPaG. Next by analyzing standard gas of helium base carbon dioxide concentration 0.5 ppm, SN ratio of carbon dioxide was 30. By setting the lower detection limit as SN ratio 3, since the lower detection limit would be 1/10 of carbon dioxide at 0.5 ppmv, the lower detection limit of carbon dioxide of the above-mentioned analyzing apparatus was obtained as 0.05 ppmv.

By using PDD method similarly as MTN/FID method, the lower detection limit of carbon dioxide was calculated. It was analyzed by using standard gas of helium base carbon dioxide concentration 10 ppm, to confirm the retention time of carbon dioxide. After filling G1 grade helium at 0.15 MPaG in a sample loop 114 (volume 1 ml), the noise width around where carbon dioxide is detected was confirmed. Next, by using PDD method and analyzing standard gas of helium base carbon dioxide concentration 0.5 ppm, by setting the pressure in the sample loop as 0.15 MPaG, SN ratio of carbon dioxide was 150. By setting the lower detection limit as SN ratio 3, since the lower detection limit would be 1/50 of carbon dioxide at 0.5 ppmv, the lower detection limit of carbon dioxide of the above-mentioned analyzing apparatus was obtained as 0.01 ppmv.

Further, for reference, the lower detection limit of carbon dioxide when using MS method similarly as MTN/FID method was also obtained. At that time, SIM monitor ion was 44. It was analyzed by using standard gas of helium base carbon dioxide concentration 10 ppm, to confirm the retention time of carbon dioxide. After filling G1 grade helium at 0.15 MPaG in a sample loop 114 (volume 1 ml), it was analyzed to confirm the noise width around where carbon dioxide is detected. Next, by using MS method and analyzing standard gas of helium base carbon dioxide concentration 0.5 ppm, by setting the pressure in the sample loop as 0.15 MPaG, SN ratio of carbon dioxide was 15. By setting the lower detection limit as SN ratio 3, since the lower detection limit would be ⅕ of carbon dioxide at 0.5 ppmv, the lower detection limit of carbon dioxide of the above-mentioned analyzing apparatus was obtained as 0. 1 ppmv.

In the following Examples 1 to 6, MTN/FID method was used, and in Example 7, PDD method was used for analysis.

### Example 1

Analyzing Apparatus By using the analyzing apparatus for surface carbon concentration of inorganic solid shown in FIG. 1, the carbon concentration of polycrystalline silicon crushed clump surface was measured. Here, in the apparatus of FIG. 1, the storage heating container 101 was one shown in FIG. 2, having a cylindrical structure made of Hastelloy. The size was as follows: outer diameter 76 mm, inner diameter 70 mm, inner side length 500 mm, flange thickness 10 mm (20 mm for 2), flange outer diameter 145 mm.

In the “inner space” of the above container, the storage heating part 103 of polycrystalline silicon crushed clump was to the position of 200 mm in the axis direction from one end toward the other end side, and the structure was one provided with a partition wall consisting of porous plate (pore diameter of communication pore 5 mm, void space rate 20%) at that place. Specifically, the other end side from the part provided with the partition wall is the extended part 105 (part having a length from the partition wall to the other end 300 mm), and on the outer end surface, an opening for polycrystalline silicon crushed clump 104 was provided. The opening for polycrystalline silicon crushed clump 104 was provided with a flange on the outer end peripheral wall, and engaged with the plate-form lid material, and fixed with bolts at plural places to be openable and closable. On the outer end peripheral wall, on the engagement surface of the flange and the plate-form lid material, the standard sealing material made of perfluoroelastomer “DUPRA” (product name; manufactured by TOHO KASEI) was intervened, and the airtightness inside the container was maintained.

Further, in the analyzing apparatus of FIG. 1, the volume of the sample loop 114 was 1 ml.

### Pretreatment of the Storage Heating Container

Before starting the measurement, after introducing G1 air at 0.4 MPaG in a storage heating container, air displacement operation to decompress to 0.01 MPaG was repeated 5 times. In the air displacement operation, the inner air discharged from the container by decompression passed through the sample loop 114 from the gas discharge pipe 108, and by flow channel selection of the six-valve 112, it flew through the out of system-discharging pipe 117 to be discharged out of the system. Then, the air displacement operation was performed again, and at that time inner air that has passed through the sample loop 114 was introduced into column 115 by switching the flow channel selection of the six-valve 112. By measuring the carbon dioxide concentration, it was non-detected (less than 0.05 ppmv).

Then, similarly, the air displacement operation was performed again, and in a state of the atmosphere in the container being the G1 air, heating with the resistance heating oven 106 was started, and after reaching 750° C. 15 min. later, it was maintained at the same temperature for 1 hour. After colling to 25° C., carbon dioxide concentration of the container atmosphere after the heating treatment was measured, and the void heating of the container by performing the air displacement was repeated 4 times. As a result, with the first void heating, carbon dioxide concentration of the container atmosphere was 1000 ppm, while by repeating the void heating 4 times, the carbon dioxide concentration could be decreased to non-detected.

### Analysis of Surface Carbon Concentration of Polycrystalline Silicon Crushed Clump

After the above void heating operation, 565 g of polycrystalline silicon crushed clump (one month after manufacturing) was stored in the storage heating part 103 of the storage heating container 101. The polycrystalline silicon crushed clump had a size which at least 90 mass % had a length of longer diameter of within the range of 20 to 100 mm. Then, by performing air displacement of the container similarly as above, it was pressurized with air to 0.5 MPaG. 20 min. after starting heating with the resistance heating oven 106, the temperature in the oven (atmosphere temperature in the periphery of end part provided with the storage heating part 2 for inorganic solid, in the storage heating container 1) reached 750° C., and it was maintained at the same temperature for further 1 hour. With the same conditions, by measuring the inner space temperature in the vicinity of polycrystalline silicon crushed clump in the storage heating part 103, it was 650° C. Further, by measuring the inner space temperature on the outer end surface of the extended part 105, it was 150° C.

After the heating for 1 hour, and cooling so that the inner space temperature in the vicinity of polycrystalline silicon crushed clump to be 25° C., by analyzing carbon dioxide concentration of the container atmosphere after the heating treatment, it was 9.6 ppm. The calculation of the carbon dioxide concentration was performed by preparing each sample gas having carbon dioxide concentration of 0.5 ppmv, 1ppmv, 10 ppmv, based on G1 grade helium (carbon dioxide 0 ppmv), and using a standard curve prepared by analyzing these 4 points.

From the obtained carbon dioxide concentration of the container atmosphere, carbon concentration of polycrystalline silicon crushed clump surface was obtained by the method explained in the [Reduction for obtaining carbon level of inorganic solid surface from the results of analysis of carbon dioxide level of combustion gas]. The result was 71 ppbw (carbon concentration of inorganic solid surface). The lower detection limit of carbon concentration of polycrystalline silicon crushed clump surface with the present Example condition was 0.36 ppbw, and this was significantly superior as compared to the general lower quantification limit (about 0.1 ppmw) with a method applying combustion-infrared absorptiometric method,

### Example 2

Except changing the polycrystalline silicon crushed clump being the subject of analysis of the Example 1 to one having a fine particle diameter, in which at least 90 mass % has a length of longer diameter within the range of 10 to 30 mm, it was similarly performed.

By analyzing the carbon dioxide concentration of the container atmosphere after performing heating treatment to 550 g of polycrystalline silicon crushed clump, the result was 12.4 ppm. From this value, carbon concentration of polycrystalline silicon crushed clump was obtained. The result was 94 ppbw (carbon concentration of inorganic solid surface).

### Example 3

Except changing the gas to introduce in the container in (Pretreatment of the storage heating container) and (Measurement surface carbon level of polycrystalline silicon crushed clump) in Example 1 from G1 air to G1 oxygen, it was similarly performed.

In the measurement, with the carbon dioxide concentration measurement of the container atmosphere after introducing G1 oxygen in the storage heating container in (Pretreatment of the storage heating container), carbon dioxide was non-detected, and with the subsequent measurement of carbon dioxide concentration of the container atmosphere by performing void heating, the result was the same as

### Example 1

As for the results of performing measurement of 555 g of polycrystalline silicon crushed clump, the carbon dioxide concentration of the container atmosphere was 9.2 ppm, and the surface carbon concentration was 70 ppbw (carbon concentration of inorganic solid surface).

### Example 4

Except using 545 g of polycrystalline silicon crushed clump within 2 days from manufacturing, it was performed similarly as Example 1. The result was as follows. The carbon dioxide concentration of the container atmosphere after heating treatment was 4.9 ppm. From this value, carbon concentration of polycrystalline silicon crushed clump surface was obtained. The result was 38 ppbw (carbon concentration of inorganic solid surface).

### Example 5

Except changing the organic solid being the subject of analysis in Example 1 from polycrystalline silicon crushed clump to Hastelloy plate (size per plate, length 100 mm, width 20 mm, thickness 2 mm) 1740 g, it was performed similarly. Hastelloy plate was previously heated with Muffle oven at 900° C. was used.

The result was as follows: Carbon dioxide concentration of the container atmosphere after heating treatment was 3.5 ppm. From this value, carbon concentration of Hastelloy plate surface was obtained. The result was 11 ppbw (carbon concentration of inorganic solid surface).

### Example 6

The present Example was performed by inclining the storage heating container 101. The basic operation was the same as Example 1.

Specifically, first, polycrystalline silicon (one month after manufacturing) 550 g was stored in the storage heating container 101. After performing air displacement, it was pressurized with air to 0.5 Mpa. When putting the storage heating container 101 in the resistance heating oven 106, the storage heating container was inclined by 20° in the direction of gravitational force so that the outer end surface of the extended part 105 is positioned on a lower part. By starting the heating with the resistance heating oven 106, the temperature in the oven reached 750° C. 15 min later. Further, heating was maintained at the same temperature for 1 hour. In this condition, by measuring the inner space temperature in the vicinity of polycrystalline silicon crushed clump in the storage heating part 103 after heating, it was 700° C. Further, by measuring the inner space temperature on the outer end surface of the extended part 105, it was 50° C. When arranging the storage heating container 101 in the resistance heating oven 106, by providing an inclination in the direction of gravitational force, the inner space temperature in the vicinity of polycrystalline silicon crushed clump in the storage heating part 103 was higher, and it was confirmed that the time required for heating the storage heating container could be reduced.

After the heating for 1 hour, and after cooling so that the inner space temperature in the vicinity of polycrystalline silicon crushed clump is 25° C., by measuring carbon dioxide of the container atmosphere after the treatment, it was 9.2 ppm, and the surface carbon concentration was 71 ppbw (carbon concentration of inorganic solid surface).

### Example 7

Except changing the detector of GC to PDD method in Example 1, it was performed similarly. As a result of measuring 562 g of polycrystalline silicon crushed clump, carbon dioxide concentration of the container atmosphere was 9.33 ppm, and the surface carbon concentration was 69.5 ppbw (carbon concentration of inorganic solid surface). Since PDD method is excellent in the lower detection limit of carbon dioxide, the surface carbon concentration could be measured with higher accuracy.

### EXPLANATION OF REFERENCE SIGNS

1: storage heating container
2: inorganic solid
3: storage heating part
4: opening for inorganic solid
5: extended part
6: circumferential lib
7: plate-form lid material
8: bolt
9: gas supply pipe
10: inner gas-discharging pipe
11: partition wall
12: supporting rod
13: communication hole
101: storage heating container
102: carbon dioxide analyzing part
103: storage heating part of inorganic solid
104: opening for inorganic solid
105: extended part
106: resistance heating oven
107: gas supply pipe
108: inner air-discharging pipe
109, 110, 111, 113: on-off valve
112: six-valve
114: sample loop
115: column
116: helium line
117: out of system-discharging pipe

1. A method for measuring surface carbon level of an inorganic solid, comprising heating under oxygen containing atmosphere the inorganic solid stored in an airtight container adjusted to a pressure higher than the atmospheric air pressure to burn a surface of the inorganic solid, introducing a container atmosphere after burning to an analyzing apparatus via an inner-air discharging pipe connected to the airtight container, analyzing an oxygen dioxide level in the container atmosphere after burning by gas chromatography method using the analyzing apparatus, and obtaining a carbon level of the inorganic solid surface from the obtained result of analysis.

2. The method for measuring surface carbon level of an inorganic solid according to claim 1, wherein the inorganic solid is a polycrystalline silicon crushed clump.

3. The method for measuring surface carbon level of an inorganic solid according to claim 2, wherein the polycrystalline silicon crushed clump has a size which at least 90 mass % has a length of longest diameter within a range of 10 to 1000 mm, and a storage level of the polycrystalline silicon crushed clump in the airtight container is 40 g or more.

4. The method for measuring surface carbon level of an inorganic solid according to claim 1, wherein a part of a wall surface of the airtight container is extended in the outer direction to form an extended part, and an opening for inorganic solid which is openable and closable by a lid material is provided on an outer end surface of the extended part.

5. The method for measuring surface carbon level of an inorganic solid according to claim 4, wherein a length of the extended part in the airtight container is a length which temperature of an inner space temperature of the outer end surface becomes 200° C. or less when burning the surface of the inorganic solid.

6. The method for measuring surface carbon level of an inorganic solid according to claim 1, wherein the airtight container has a cylindrical structure, and a container heating part which stores and heats the inorganic solid is provided in an inner space of one outer end side, and the opening for inorganic solid is provided on the other outer end surface.

7. The method for measuring surface carbon level of an inorganic solid according to claim 1, wherein the airtight container is made of Hastelloy.

8. The method for measuring surface carbon level of an inorganic solid according to claim 6, wherein one side provided with the container heating part of the airtight container is positioned in an upper part, and the other side provided with the opening for inorganic solid is positioned in a lower part.

9. The method for measuring surface carbon level of an inorganic solid according to claim 1, wherein the analysis of oxygen dioxide level in the gas chromatography method is an analysis using Methanizer (MTN)/Flame Inonization Detector (FID), or a Pulsed Discharge Photo-Ionization Detector (PDD).

10. An analyzing apparatus for obtaining carbon level of an inorganic solid surface comprising:
an airtight container adjusted to a pressure higher than the atmospheric air pressure, that is bumable by heating a surface of an inorganic solid which is a stored product under oxygen containing atmosphere, and
a carbon dioxide analyzing part for analyzing carbon dioxide level in an atmosphere of the airtight container by gas chromatography method, which is provided via an inner air-discharging pipe connected to the airtight container

11. The analyzing apparatus according to claim 10, wherein a part of a wall surface of the airtight container is extended in the outer direction to form an extended part, and an opening for inorganic solid which is openable and closable by a lid material is provided on an outer end surface of the extended part.

12. The analyzing apparatus according to claim 11, wherein a length of the extended part in the airtight container is a length which temperature of an inner space temperature of the outer end surface becomes 200° C. or less.

13. The analyzing apparatus according to claim 10, wherein the airtight container has a cylindrical structure, and a container heating part which stores and heats the inorganic solid is provided in the inner space of one outer end side, and the opening for inorganic solid is provided on the other outer end surface.

14. The analyzing apparatus according to claim 10, wherein the airtight container is made of Hastelloy.

15. The analyzing apparatus according to claim 13, wherein one side provided with the container heating part of the airtight container is positioned in an upper part, and the other side provided with the opening for inorganic solid is positioned in a lower part.

16. The analyzing apparatus according to claim 10, wherein the carbon dioxide analyzing part comprises Methanizer (MTN)/Flame Inonization Detector (FID), or a Pulsed Discharge Photo-Ionization Detector (PDD).
